(19) United States
(12) Patent Application Publication
(10) Pub. No.: US 2026/0152408 A1
(43) Pub. Date: Jun. 4, 2026

(54) A METHOD FOR PRODUCING AN ALUMINOUS MATERIAL

(71) Applicant: Sara COUPERTHWAITE

(72) Inventor: Sara COUPERTHWAITE

(21) Appl. No.: 18/872,472

(22) PCT Filed: Jun. 3, 2023
(86) PCT No.: PCT/AU2023/050483

§ 371 Date: Dec. 6, 2024

(51) Int. Cl. C01F 7/62; C01F 7/30; C01F 7/441

(52) U.S. Cl. CPC C01F 7/62; C01F 7/30; C01F 7/441; C01P 2002/02; C01P 2004/61; C01P 2006/80

(57) ABSTRACT

The present invention relates to a method for producing an aluminous material, in particular, aluminium oxyhydroxychlorides and alpha alumina. The method comprising providing an aluminium-containing feedstock and separating the aluminium-containing feedstock to provide a pregnant liquor. The pregnant liquor is concentrated to obtain a saturated aluminium solution and subjected to a crystallisation process. The aluminium chloride hexahydrate crystals slurry is cooled, and the crystals separated from a spent liquor. The aluminium chloride hexahydrate crystals is heated under controlled air flow to obtain dehydrated aluminium oxyhydroxychlorides. Optionally, the aluminium chloride hexahydrate crystals may be dried under at least a partial vacuum before being heated under controlled air flow. The aluminium oxyhydroxychlorides may be subsequently decomposed and calcined to form primarily alpha alumina.

### TECHNICAL FIELD

The present invention relates to a method for producing an aluminous material. In particular, the present invention relates to a method for producing aluminium oxyhydroxychlorides and alpha alumina.

### BACKGROUND

There are several known processes used for the production of aluminium oxide or alumina. These processes are based on an alkaline extraction process, such as the Bayer process, or an acid extraction process. In particular, acid extraction processes have been used for the extraction of aluminium from non-bauxite materials.

In 1927, the United States Bureau of Mines published a comparative study on the extraction of aluminium from non-bauxite materials, such as kaolinitic clays, using strong acids such as sulphuric acid, nitric acid and hydrochloric acid.

In 1946, the United States Bureau of Mines published a paper describing the development of a hydrochloric acid process to produce alumina from clay. That and subsequent publications describe the basic process as follows:
Treating (such as by crushing, air flotation, or the like) the aluminous materials, such as kaolinitic material, as necessary to reduce particle size and increase the aluminium content;
Roasting (also known as calcining or thermal dehydroxylation) the kaolinitic material to produce metakaolin which is more soluble in dilute acid than kaolin;
Digesting (also known as leaching or acid dissolution) the aluminous material with hydrochloric acid to form a slurry;
Filtering the slurry to separate the solid and liquid phases, wherein the solid comprises insoluble siliceous matter and the pregnant liquor comprises a solution containing the aluminium and soluble impurities;
Precipitating (also known as crystallisation, recrystallisation or salting-out) aluminium chloride hexahydrate crystals by sparging with hydrogen chloride gas, and crystallising the hydrated chloride of aluminium (aluminium chloride hexahydrate);
Calcining (also known as ignition, heating, decomposition, pyrolysis or hydro-pyrolysis) the aluminium chloride hexahydrate to provide alumina, and
Recovering (also known as recycling) hydrogen chloride for reuse as leaching acid, a washing liquid, or gas for aluminium chloride hexahydrate crystallisation.

Subsequent research has, to a large extent, focussed on identifying ranges of conditions at various stages throughout the alumina manufacturing process to optimise the hydrochloric acid extraction of alumina from kaolinitic clays.

However, the prior art is replete with problems. For example, the particle size of alumina produced using present methods may be too large for some applications which requires the alumina to be milled in order to produce the desired particle size. However, use of milling processes may increase the risk of introduction of contaminants into the alumina, which is difficult to remove from the end product, as well as requiring additional energy inputs into the system.

In addition, current processes may result in high residual chloride levels which causes the material, and especially, the aluminium chloride hexahydrate to not flow easily through the reaction vessel and to cake into coatings on the surface of the reaction vessel resulting in poor and uneven heating of the material being decomposed. The release of gaseous hydrogen chloride during drying may also cause corrosion of reaction vessels in which pyrolysis occurs requiring expensive maintenance or the purchase of customised drying equipment.

Furthermore, hydrogen chloride gas is valuable as a recyclable chemical, however, during the production of aluminium oxide or alumina from clay, hydrogen chloride gas is difficult to capture or recycle and existing methods, such as those disclosed in JP2013-203598, occur at higher temperatures than optimum for capture.

Further, the intermediate reaction product, aluminium chloride hexahydrate is hygroscopic and unstable, cementitious with very poor flowing properties and may release gaseous hydrogen chloride during storage which is dangerous to human health and highly corrosive.

Still further, the prior art processes are unable to effectively reduce contaminants to the level required by users of high purity (>99.99% pure) alumina, such as chromium, magnesium and phosphorus, such contaminants being commonly found in aluminium-containing feedstocks that have sufficient aluminium content to be used to product alumina.

It will be clearly understood that, if a prior art publication is referred to herein, this reference does not constitute an admission that the publication forms part of the common general knowledge in the art in Australia or in any other country.

### SUMMARY OF INVENTION

Embodiments of the present invention provide a method for producing an aluminous material, which may at least partially address one or more of the problems or deficiencies mentioned above or which may provide the public with a useful or commercial choice.

As used herein, the term “oxyhydroxychlorides” is intended to refer to an intermediate product in the formation of alumina formed by heating aluminium chloride hexahydrate crystals at low temperatures. Oxyhydroxychlorides comprise a mixture of dehydrated aluminium oxychloride species with a low concentration of free chloride and which are generally chemically stable with good flowing properties.

As used herein, the term “at least a partial vacuum” means a reduction of the pressure inside a vessel relative to the pressure outside the vessel. It will be understood that, typically, the term “at least a partial vacuum” refers to a sub-atmospheric pressure.

As used herein, the term “roasting” is intended to refer to a heating process which causes the dehydroxylation of a mineral-containing feedstock. It is also commonly referred to as calcining or thermal dehydroxylation.

As used herein, the term “digesting” is intended to refer to a solvent extraction process using strong acids or bases to digest or leach minerals from a mineral-containing feedstock. It is also commonly referred to as leaching or acid dissolution.

As used herein, the term “precipitation” is intended to refer to the process whereby solid material separates from solution. It is also commonly referred to as crystallisation, recrystallisation or salting-out.

As used herein, the term “calcining” is intended to refer to a high temperature heating process whereby a mineral-containing material is converted to its oxide form. It is also commonly referred to as ignition, heating, decomposition, pyrolysis or hydro-pyrolysis.

As used herein, the term “recovering” is intended to refer to the recovery of solvent for reuse. It is also commonly referred to as recycling.

According to a first aspect of the present invention, there is provided a method for producing an aluminous material including:
providing an aluminium-containing feedstock;
separating the aluminium-containing feedstock to provide a pregnant liquor;
concentrating the pregnant liquor to obtain a saturated aluminium solution;
subjecting the saturated aluminium solution to a crystallisation process, the crystallisation process including:
heating the saturated aluminium solution;
sparging the saturated aluminium solution with gaseous hydrochloric acid to form a slurry of aluminium chloride hexahydrate crystals;
separating the aluminium chloride hexahydrate crystals from a spent liquor; and
heating the aluminium chloride hexahydrate crystals under controlled air flow at a temperature of between about 100° C. and about 350° C. to obtain dehydrated aluminium oxyhydroxychlorides.

It will be understood that the term “dehydrated aluminium oxyhydroxychlorides” is intended to refer to aluminium oxyhydroxychlorides from which at least a portion of the water associated therewith has been removed. Any suitable quantity of water may be removed to form the dehydrated aluminium oxyhydroxychlorides. For instance, in some embodiments of the invention, at least 10% w/w of the water associated with the aluminium oxyhydroxychlorides is removed to form the dehydrated aluminium oxyhydroxychlorides. More preferably, at least 25% w/w of the water associated with the aluminium oxyhydroxychlorides is removed to form the dehydrated aluminium oxyhydroxychlorides. More preferably, at least 50% w/w of the water associated with the aluminium oxyhydroxychlorides is removed to form the dehydrated aluminium oxyhydroxychlorides. More preferably, at least 75% w/w of the water associated with the aluminium oxyhydroxychlorides is removed to form the dehydrated aluminium oxyhydroxychlorides. More preferably, at least 90% w/w of the water associated with the aluminium oxyhydroxychlorides is removed to form the dehydrated aluminium oxyhydroxychlorides. In some embodiments, substantially all of the water associated with the aluminium oxyhydroxychlorides is removed to form the dehydrated aluminium oxyhydroxychlorides.

As indicated, an aluminium-containing feedstock may be provided.

Any suitable type of aluminium-containing feedstock may be used.

In some embodiments, the aluminium-containing feedstock may be a source of alumina, aluminium hydroxide, aluminium metal, aluminium chloride hexahydrate, red mud, fly ash, aluminosilicates, kaolin, zeolite, feldspar, or the like.

In some embodiments, the aluminium-containing feedstock may be roasted. In this instance, it will be understood that the aluminium-containing feedstock may have been subjected to a heating process to reduce impurities or to thermally dehydroxylate the aluminium-containing feedstock.

In other embodiments, the aluminium-containing feedstock may be formed by dispersing the aluminium-containing feedstock in a solvent.

Any suitable solvent may be used. Generally, the solvent may be sufficient to leach aluminium from the aluminium-containing feedstock. For instance, the solvent may be a strong acid such as hydrochloric acid, sulphuric acid, nitric acid or the like.

The aluminium-containing feedstock may be at any suitable pulp density. For example, the aluminium-containing feedstock may be about 10% pulp density, about 15% pulp density, about 20% pulp density, about 25% pulp density.

In preferred embodiments, the aluminium-containing feedstock may be about 20% pulp density.

In some embodiments, the aluminium-containing feedstock may be kaolin, wherein the kaolin may be roasted to form metakaolin and then leached with hydrochloric acid to form an aluminium-containing feedstock.

In some embodiments, the aluminium-containing feedstock may be mining tailings or aluminium-containing waste material which may be leached using hydrochloric acid to extract aluminium.

As indicated, the aluminium-containing feedstock may be separated to provide a pregnant liquor.

The aluminium-containing feedstock may be separated using any suitable technique known in the art. Preferably, the separation technique may be sufficient to separate the aluminium-containing feedstock into a pregnant liquor and a solid residue. For instance, the separation technique may include gravity settling clarifiers, sedimentation, decanting, centrifugation, filtration, or the like.

In some embodiments, the pregnant liquor may be polished.

The pregnant liquor may be polished or clarified using any suitable technique known in the art. Preferably, the polishing step may be sufficient to remove or reduce suspended solids such as fine precipitate, insoluble material, or the like. In some embodiments, the pregnant liquor may be polished or clarified using a filtration process and/or flocculants.

As indicated, the pregnant liquor may be concentrated to obtain a saturated aluminium solution.

The pregnant liquor may be concentrated using any suitable technique known in the art. Generally, the concentration technique may be sufficient to increase the aluminium in the pregnant liquor to its saturation point without precipitating the aluminium as aluminium chloride hexahydrate crystals. For instance, the pregnant liquor may be concentrated by heating the pregnant liquor to its boiling point, by evaporation by heating the pregnant liquor below its boiling point, or the like. The concentrated pregnant liquor may undergo a polishing step to remove insoluble contaminants such as silica or other precipitates.

Preferably, the pregnant liquor may be concentrated to its saturation point by evaporation.

The pregnant liquor may be concentrated by boiling the pregnant liquor at a temperature of between about 75° C. and about 130° C., between about 85° C. and about 120° C., preferably between about 95° C. and about 110° C. In some embodiments, the pregnant liquor may be concentrated by boiling the pregnant liquor at a temperature of between about 95° C. and about 110° C.

However, it will be appreciated by a person skilled in the art that the temperature may vary depending on a number of factors, including whether concentration is performed under vacuum, the level and type of impurities, and the molarity of hydrochloric acid.

In some embodiments, the pregnant liquor may be concentrated to an aluminium concentration of about 60,000 ppm.

Advantageously, concentrating the pregnant liquor may reduce the consumption of hydrogen chloride gas per unit of precipitated aluminium chloride hexahydrate during crystallisation. Further, at the same given gas flow rate, the seed nucleation phase may be decreased relative to the growth phase, reducing the overall incorporation of impurities from the liquor which may be more readily captured at nucleation.

As indicated, the saturated solution may be subjected to a crystallisation process.

Any suitable crystallisation process may be used. Generally, the crystallisation process may be sufficient to precipitate out the aluminium chloride hexahydrate crystals and minimise the precipitation of impurities.

Preferably, the crystallisation process may include heating the saturated aluminium solution and sparging the saturated aluminium solution with gaseous hydrochloric acid to force crystallisation of and form a slurry of aluminium chloride hexahydrate crystals.

Any suitable type of gaseous hydrochloric acid may be used. For instance, the gaseous hydrochloric acid may be purified, enriched, or the like.

The saturated aluminium solution may be added to a stirred reaction vessel. In some embodiments, the stirred reaction vessel may be heated.

The saturated aluminium solution may be pre-heated to any suitable temperature. For instance, the saturated aluminium solution may be pre-heated at a temperature of between about 30° C. and about 100° C., between about 40° C. and about 90° C., between about 50° C. and about 80° C., between about 60° C. and about 70° C.

In some embodiments, the saturated aluminium solution may be pre-heated to a temperature of between about 60° C. and about 70° C.

The saturated aluminium solution may be sparged with gaseous hydrochloric acid at a reaction temperature of between about 40° C. and about 120° C., between about 50° C. and about 110° C., between about 60° C. and about 100° C., preferably between about 70 and 90° C.

In some embodiments, the saturated aluminium solution may be sparged with gaseous hydrochloric acid held at a reaction temperature of between about 60° C. and about 70 ° C.

The saturated aluminium solution may be sparged with gaseous hydrochloric acid until the saturated aluminium solution attains a hydrochloric acid concentration of between about 20% by weight and about 45% by weight, between about 25% by weight and 40% by weight, preferably between about 30% by weight and 35% by weight.

In some embodiments, the saturated aluminium solution may be sparged with gaseous hydrochloric acid until the saturated aluminium solution attains a hydrochloric acid concentration of between about 30% by weight and 34% by weight.

Advantageously, pre-heating the saturated aluminium solution prior to sparging with gaseous hydrochloric acid reduces the incorporation of contaminants, such as phosphorous and magnesium, in the precipitate by slowing crystallisation and decreasing rates of nucleation. In addition, pre-heating the saturated aluminium solution prior to sparging with gaseous hydrochloric acid may increase the purity achieved during crystallisation reducing the number of recrystallisation steps required.

In some embodiments, the slurry of aluminium chloride hexahydrate crystals may be subjected to one or more recrystallisation steps. Generally, the person skilled in the art will appreciate that recrystallisation may be performed on crystals formed from a crystallisation method to reduce or remove any impurities in the compound received from crystallisation.

In this instance, it is envisaged that the slurry of aluminium chloride hexahydrate crystals obtained from the crystallisation of the saturated solution of aluminium chloride hexahydrate may be subjected to one or more recrystallisation steps before undergoing pyrolysis.

The slurry of aluminium chloride hexahydrate crystals may be recrystallised using any suitable technique known in the art. Generally, the recrystallisation process may be sufficient to precipitate out purified aluminium chloride hexahydrate crystals and minimise the precipitation of impurities.

The recrystallisation process may comprise separating and washing the precipitated crystals and then dissolving the washed precipitated crystals in a solvent (such as ultra-pure water, demineralised water, or the like) to form a feed liquor. The feed liquor may undergo a polishing step to remove insoluble contaminants such as silica. The feed liquor may then be heated and sparged with gaseous hydrochloric acid to precipitate aluminium chloride hexahydrate crystals.

In some embodiments, the aluminium chloride hexahydrate crystal slurry may be cooled before the aluminium chloride hexahydrate crystals are separated from the spent liquor. Preferably, the aluminium chloride hexahydrate solution may be cooled during the final crystallisation and/or recrystallisation step.

The aluminium chloride hexahydrate solution may be cooled using any suitable technique. For instance, the aluminium chloride hexahydrate solution may be actively cooled, such as by being refrigerated or the like. Alternatively, the aluminium chloride hexahydrate solution may be cooled by removing a heating source and allowing the aluminium chloride hexahydrate solution to cool to ambient temperature over a period of time. Advantageously, cooling of the aluminium chloride hexahydrate solution improves hydrogen chloride recovery.

The aluminium chloride hexahydrate solution may be cooled to any suitable temperature. Generally, the aluminium chloride hexahydrate solution may be cooled to a temperature sufficient to crystalise relatively small aluminium chloride hexahydrate crystals without crystalising out impurities.

In some embodiments, the aluminium chloride hydroxide solution may be cooled to a temperature of less than about 0 ° C. More preferably, the aluminium chloride hydroxide solution may be cooled to a temperature of less than about −5° C. More preferably, the aluminium chloride hydroxide solution may be cooled to a temperature of less than about −10° C. Still more preferably, the aluminium chloride hydroxide solution may be cooled to a temperature of less than about −15° C. Yet more preferably, the aluminium chloride hydroxide solution may be cooled to a temperature of less than about −20° C. Most preferably, the aluminium chloride hydroxide solution may be cooled to a temperature of less than about −25° C. The aluminium chloride hexahydrate solution may be agitated during cooling. In use, it is envisaged that agitating the solution during cooling may assist in avoiding formation of aggregates and assists in the formation of smaller particles.

Advantageously, cooling the aluminium chloride hexahydrate solution to a sufficiently low temperature and agitating the solution during cooling produces crystals with a smaller particle size than traditional practices (less than about 10 μm compared to an average particle size of about 20 μm to about 100 μm) and increases rates of nucleation rather than crystal growth.

The precipitate may be separated using any suitable technique known in the art. Preferably, the separation technique may be sufficient to separate the precipitate from a spent liquor. For instance, the separation technique may include gravity settling clarifiers, sedimentation, decanting, centrifugation, filtration, or the like.

The precipitate may be washed to separate the aluminium chloride hexahydrate crystals from impurities in the precipitate.

The precipitate may be washed with any suitable wash liquid. Generally, the wash liquid may be sufficient to redissolve soluble contaminants or the like from the crystals. The wash liquid may be sufficient to also displace the entrained contaminated supernatant and replace with the less-contaminated wash liquid.

In some embodiments, the wash liquid may be hydrochloric acid, spent liquor, or the like. The wash liquid used to wash a precipitate obtained from the crystallisation of the saturated solution may be the same as the wash liquid used to wash a precipitate obtained from the recrystallisation of a feed liquor, or may be different.

The aluminium chloride hexahydrate crystals may be separated from excess hydrochloric acid using any suitable technique known in the art. For instance, the separation technique may include gravity settling clarifiers, sedimentation, decanting, centrifugation, filtration, or the like.

As indicated, the aluminium chloride hexahydrate crystals may be heated under controlled air flow at a temperature of between about 100° C. and about 350° C. to obtain aluminium oxyhydroxychloride The aluminium chloride hexahydrate crystals may be heated using any suitable technique known in the art. Generally, the heating technique may be sufficient to provide a heating profile that dries the aluminium chloride hexahydrate and produces dehydrated aluminium oxyhydroxychlorides.

Preferably, aluminium chloride hexahydrate crystals may be heated under controlled air flow conditions. For instance, the aluminium chloride hexahydrate crystals may be heated directly or indirectly. Heat sources may include a forced air-drying oven, a flash dryer, a fluidised bed dryer, microwave ovens, rotary kilns, tunnel furnaces, fluid bed reactors, far infrared rays, high frequency waves or the like. A person skilled in the art will appreciate that under controlled air flow conditions, air is directed into a vessel such that it contacts the aluminium chloride hexahydrate crystals and assists in the removal of water and hydrochloric acid vapour from the vessel.

In some embodiments, the vessel may be heated. Preferably, the aluminium chloride hexahydrate crystals may be heated in a heated vessel under heated and/or dry air flow.

The aluminium chloride hexahydrate crystals may be heated at any suitable hold temperature. However, a person skilled in the art will appreciate that the hold temperature may vary depending on a number of factors, including the hold time, the air flow conditions, and the amount and type of liquor present in the crystals and the desired end characteristics of the formed aluminium oxyhydroxychlorides.

The aluminium chloride hexahydrate crystals may be heated at a hold temperature of between about 100° C. and about 350° C., between about 150° C. and about 280° C., between about 170° C. and about 250° C., preferably between about 180° C. and about 230° C. Most preferably, the aluminium chloride hexahydrate crystals may be heated at a hold temperature of about 230° C.

Preferably, the aluminium chloride hexahydrate crystals are heated under controlled air flow at a temperature of between about 180° C. and 230° C. to obtain dehydrated aluminium oxyhydroxychlorides.

In some embodiments, the aluminium chloride hexahydrate crystals may be heated at a hold temperature of less than about 230° C.

It is envisaged that, by heating the aluminium chloride hexahydrate crystals at these relatively low drying temperatures, hydrochloric acid gas vapour may be recovered from the drying process using any suitable technique. The recovery of hydrochloric gas vapour may generate useful heat, thereby reducing energy input requirements, while also allowing the recovery of a reagent for further use.

In addition, by drying the aluminium chloride hexahydrate crystals under controlled air flow, the recovery of hydrochloric acid may be improved, and the condensation of acids on reactor surfaces (thereby resulting in corrosion) may be reduced or eliminated.

Any suitable ramp rate (rate of temperature change over time) may be used to reach the hold temperature. For example, the ramp rate may be about 10° C. per minute, about 20° C. per minute, about 30° C. per minute, about 40° C. per minute, about 50° C. per minute, about 75° C. per minute, about 100° C. per minute, or more.

In use, it is envisaged that the ramp rate may be chosen to reach the hold temperature as quickly as possible.

The aluminium chloride hexahydrate crystals may be heated at a hold temperature for any suitable period of time. However, it will be appreciated by a person skilled in the art, that the hold time may vary depending on a number of factors, including the hold temperature, the air flow conditions, and the amount and type of liquor present in the crystals.

For instance, the aluminium chloride hexahydrate crystals may be heated at a hold temperature for a period of at least about at least about 30 minutes, at least 60 minutes, at least about 90 minutes, at least about 2 hours, at least about 3 hours, at least about 4 hours, at least about 5 hours, at least about 6 hours, or more.

Preferably, the aluminium chloride hexahydrate crystals may be agitated while being heated under controlled air flow conditions. In use, it is envisaged that agitating the crystals while heating may break up any aggregates formed and assist in particle size reduction of the crystals. In addition, heating the aluminium chloride hexahydrate crystals under controlled air flow conditions may assist in deagglomeration and/or particle size reduction of the crystals through the introduction of high velocity air into the vessel. In other embodiments, the aluminium chloride hexahydrate crystals may undergo a particle size reduction process before, during, or after heating under controlled air flow conditions.

In some embodiments, the aluminium oxyhydroxychlorides formed by heating the aluminium chloride hexahydrate crystals comprises residual chloride levels of about 2% by weight to about 10% by weight of the aluminium oxyhydroxychlorides.

In some embodiments, the aluminium oxyhydroxychlorides comprises particles which may pass through a mesh aperture of up to about 10 μm, preferably up to about 5 μm, yet more preferably up to about 2 μm.

Advantageously, heating the aluminium chloride hexahydrate crystals under controlled air flow conditions removes entrained liquor which can condense inside the heating apparatus and cause caking and formation of cementitious material, leading to uneven drying and decomposition of the aluminium chloride hexahydrate crystals.

Advantageously, decomposition of aluminium chloride hexahydrate to dehydrated aluminium oxyhydroxychlorides results in a more stable alumina precursor as aluminium chloride hexahydrate may be corrosive, hygroscopic and releases gaseous hydrogen chloride over time. In addition, aluminium chloride hexahydrate readily absorbs ambient moisture resulting in the formation of rock-like aggregates which are substantially more difficult to heat and introduce uncontrollable variability as they may retain more chloride. Further, dehydrated aluminium oxyhydroxychlorides are a free-flowing material which may be easier to handle and stable when stored over an extended period of time.

Preferably, the method for producing an aluminous material according to a first aspect of the invention further includes:
drying the aluminium chloride hexahydrate crystals at a temperature of between about 50° C. and 150° C. under at least a partial vacuum before the aluminium chloride hexahydrate crystals are heated under controlled air flow at a temperature of between about 100° C. and about 350° C. to obtain dehydrated aluminium oxyhydroxychlorides.

The aluminium chloride hexahydrate crystals may be dried under any suitable pressure. General, the partial vacuum may be sufficient to aid in the removal of water by reducing the boiling point of water.

In some embodiments, the aluminium chloride hexahydrate crystals may be dried under a pressure of between about 50 mBar to about 1000 mBar, more preferably between about 100 mBar to about 900 mBar, more preferably between about 150 mBar to about 800 mBar, more preferably between about 200 mBar to about 700 mBar, yet more preferably between about 250 mBar to about 600 mBar, still more preferably between about 300 mBar to about 500 mBar, and most preferably between about 350 mBar to about 400 mBar.

The aluminium chloride hexahydrate crystals may be dried at a temperature of between about 50° C. and about 150° C., between about 60° C. and about 140° C., preferably between about 80° C. and about 130° C.

Preferably, the aluminium chloride hexahydrate crystals may be dried at a temperature of between about 80° C. and 130° C. under at least a partial vacuum.

In some embodiments, the aluminium chloride hexahydrate crystals comprise residual chloride levels of about 30% by weight to about 45% by weight of the aluminium chloride hexahydrate crystals after the step of drying the aluminium chloride hexahydrate crystals under at least a partial vacuum.

In some embodiments, the aluminium chloride hexahydrate crystals comprise substantially no residual moisture content.

Preferably, the step of drying the aluminium chloride hexahydrate crystals at a temperature between about 50° C. and 150° C. under at least a partial vacuum occurs after the step of cooling the aluminium chloride hexahydrate crystals slurry and separating the aluminium chloride hexahydrate crystals from a spent liquor and before the step of heating the aluminium chloride hexahydrate crystals under controlled air flow at a temperature of between about 100° C. and about 350° C. to obtain dehydrated aluminium oxyhydroxychlorides.

In use it is envisaged that low temperature heating of aluminium chloride hexahydrate crystals under at least a partial vacuum may assist in reducing entrained liquor, including water, within the crystals to produce stabilised dehydrated aluminium chloride hexahydrate. The stabilised dehydrated aluminium chloride hexahydrate may then be dried to obtain aluminium oxyhydroxychlorides. In this instance, it will be understood that the low temperature heating of aluminium chloride hexahydrate crystals provides a further pyrolysis step in a method to convert aluminium chloride hexahydrate to alpha alumina.

Advantageously, low temperature drying of the aluminium chloride hexahydrate crystals under a partial vacuum to reduce entrained liquor before the crystals are dried at higher temperatures may improve the energy efficiency of the drying stages as compared to using a direct thermal drying process.

The aluminium chloride hexahydrate crystals may be heated using any suitable technique known in the art. Generally, the heating technique may be sufficient to provide a heating profile that assists in reducing entrained liquor within the aluminium chloride hexahydrate crystals without decomposing the crystals. For instance, the aluminium chloride hexahydrate crystals may be dried using aa vacuum drier, a microwave drier, a microwave-assisted vacuum drier, or any other suitable indirect drying techniques under vacuum.

In some embodiments of the invention, the aluminium chloride hexahydrate crystals may be heated using rotary kilns, tunnel furnaces, fluid bed reactors, microwave vacuum-assisted drying, far infrared rays, high frequency waves or the like.

According to a second aspect of the present invention, there is provided a method for producing an aluminous material including:
providing an aluminium-containing feedstock;
separating the aluminium-containing feedstock to provide a pregnant liquor;
concentrating the pregnant liquor to obtain a saturated aluminium solution;
subjecting the saturated aluminium solution to a crystallisation process, the crystallisation process including:
   heating the saturated aluminium solution;
   sparging the saturated aluminium solution with gaseous hydrochloric acid to form a slurry of aluminium chloride hexahydrate crystals;
separating aluminium chloride hexahydrate crystals from the slurry of aluminium chloride hexahydrate crystals to produce a spent liquor;
drying the aluminium chloride hexahydrate crystals at a temperature of between about 50° C. and 150° C. under at least a partial vacuum, and
heating the aluminium chloride hexahydrate crystals under controlled air flow at a temperature of between about 100° C. and about 350° C. to obtain aluminium oxyhydroxychloride

Preferably, the method for producing an aluminous material according to the first aspect or the second aspect of the invention further includes:
decomposing aluminium oxyhydroxychlorides at a temperature of between about 800° C. and about 980° C. to form primarily an amorphous alumina, and
calcining the decomposed amorphous alumina at a temperature of between about 1,100° C. and about 1,300° C. to obtain primarily alpha alumina.

As indicated, the aluminous material comprising aluminium oxyhydroxychlorides may be decomposed at a temperature of between about 800° C. and about 980° C. to form primarily an amorphous alumina and the amorphous alumina calcined at a temperature of between about 1,100° C. and about 1,300° C. to obtain primarily alpha alumina.

The aluminous material comprising aluminium oxyhydroxychlorides may be decomposed (for example, by means of a rotary kiln, fluidised bed, etc.) at high temperatures to transition alumina phases such as gamma alumina and amorphous alumina.

The aluminium oxyhydroxychlorides may be decomposed at any suitable temperature. Generally, the decomposition temperature may be sufficient to remove the majority of the remaining chlorides. However, a person skilled in the art will appreciate that the decomposition temperature may vary depending on a number of factors, including the decomposition time, the heat transfer rate, the particle size of the aluminium chloride hexahydrate crystals, and whether the vessel is agitated.

The aluminium oxyhydroxychlorides may be heated at a decomposition temperature of between about 600° C. and about 1,200° C., between about 700° C. and about 1,100° C., between about 800° C. and about 1,000° C.

In some embodiments, the aluminium oxyhydroxychlorides may be heated at a decomposition temperature of about 800° C.

The aluminium oxyhydroxychlorides may be heated at a decomposition temperature for any suitable period of time.

For instance, the aluminium oxyhydroxychlorides may be heated at a decomposition temperature for a period of at least about at least about 30 minutes, at least 60 minutes, at least about 90 minutes, at least about 2 hours, at least about 3 hours, at least about 4 hours, at least about 5 hours, at least about 6 hours, or more.

In some embodiments, the step of decomposing the aluminous material comprising aluminium oxyhydroxychlorides may comprise controlling the humidity in the vessel. In use, it is envisaged that controlling the humidity of the vessel may assist in promoting chloride removal prior to the calcination step.

In some embodiments, the amorphous alumina and gamma alumina formed by decomposing the aluminous material comprising aluminium oxyhydroxychlorides comprises residual chloride levels of less than about 1.5% by weight, preferably less than about 1.0% by weight, more preferably less than about 0.4% by weight of the amorphous alumina and gamma alumina.

Advantageously, lowering the residual chloride levels of the amorphous alumina and gamma alumina reduces a potential cause of corrosion in the vessel during calcination. As a result, this allows a wider selection of materials used in the construction of the vessels, kilns, calciners, and the like in which the pyrolysis occurs.

Advantageously, splitting the decomposition process into a lower temperature heating and a higher temperature decomposition stage effectively splits the process across two pieces of equipment that can each be designed for a tighter range of operating conditions, reducing the stress placed on each piece of equipment thereby reducing potential equipment failure.

As indicated, the amorphous alumina and gamma alumina may be calcined (for example, by means of a rotary kiln, fluidised bed, calciner, etc.) at high temperatures in order to obtain alumina. Preferably, the alumina obtained may comprise substantially alpha alumina.

The amorphous alumina and gamma alumina may be calcined at any suitable temperature. Generally, the calcination temperature may be sufficient to convert the amorphous alumina and gamma alumina to alpha alumina. However, a person skilled in the art will appreciate that the calcination temperature may vary depending on a number of factors, including the residence time in the calciner, equipment capability, and sintering temperature.

The amorphous alumina and gamma alumina may be heated at a calcination temperature of between about 950° C. and about 1,300° C., preferably between about 1,100° C. and about 1,300° C.

In some embodiments, the amorphous alumina and gamma alumina may be heated at a calcination temperature of between about 1,100° C. and about 1,300° C.

The amorphous alumina and gamma alumina may be heated at a calcination temperature for any suitable period of time.

For instance, the amorphous alumina and gamma alumina may be heated at a calcination temperature for a period of at least about at least about 30 minutes, at least 60 minutes, at least about 90 minutes, at least about 2 hours, at least about 3 hours, at least about 4 hours, or more.

In some embodiments, the step of calcining the amorphous alumina and gamma alumina may comprise controlling the humidity in the vessel.

Preferably, the pregnant liquor may be concentrated to its saturation point by evaporation.

Preferably, the slurry of aluminium chloride hexahydrate crystals may be subjected to one or more recrystallisation processes.

Advantageously, methods of the present invention provide improved contamination control in the production of high purity alumina. In particular, the present invention provides improved control of impurities such as silica, phosphorus, chromium and magnesium.

In addition, methods of the present invention provide improved particle size control during the formation of aluminium chloride hexahydrate. Advantageously, improved particle size control reduces the need for post-calcination processing, such as milling, which may introduce contaminants that are effectively impossible to remove. In addition, reducing the need for post-calcination processing reduces the need for additional energy inputs into the system.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of Invention in any way. The Detailed Description will make reference to a number of drawings as follows:

FIG. 1 illustrates a method of producing a high purity aluminous material according to an embodiment of the invention;

FIG. 2 illustrates a method of producing a high purity aluminous material according to an embodiment of the invention;

FIG. 3 illustrates a method of producing a high purity aluminous material according to a further embodiment of the invention;

FIG. 4 illustrates a method of producing a high purity aluminous material according to an embodiment of the invention.

### DETAILED DESCRIPTION

Unless defined otherwise, all technical and scientific terms used herein have the same meaning as would be commonly understood by those of ordinary skill in the art to which this invention belongs.

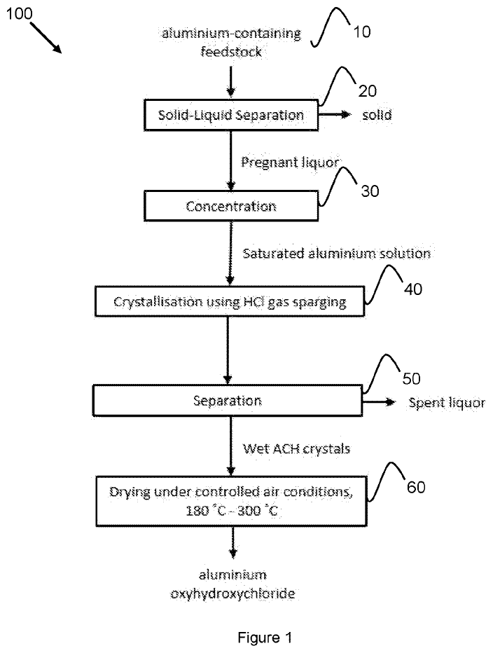

A method (100) for producing an aluminous material as shown in FIG. 1 is now described in detail. Preferably, the aluminous material comprises aluminium oxyhydroxychlorides.

At step 10, an aluminium-containing feedstock may be provided.

Any suitable type of aluminium-containing feedstock may be used.

In some embodiments, the aluminium-containing feedstock may be a source of alumina, aluminium hydroxide, aluminium metal, aluminium chloride hexahydrate, red mud, fly ash, aluminosilicates, kaolin, zeolite, feldspar, or the like.

The aluminium-containing feedstock may be formed by dispersing the aluminium-containing feedstock in a solvent.

Any suitable solvent may be used. Generally, the solvent may be sufficient to leach aluminium from the aluminium-containing feedstock. For instance, the solvent may be a strong acid such as hydrochloric acid, sulphuric acid, nitric acid or the like.

At step 20, the aluminium-containing feedstock may be separated to provide a pregnant liquor.

The aluminium-containing feedstock may be separated using any suitable technique known in the art. Preferably, the separation technique may be sufficient to separate the aluminium-containing feedstock into a pregnant liquor and a solid residue. For instance, the separation technique may include gravity settling clarifiers, sedimentation, decanting, centrifugation, filtration, or the like.

At step 30, the pregnant liquor may be concentrated to obtain a saturated aluminium solution.

The pregnant liquor may be concentrated using any suitable technique known in the art. Generally, the concentration technique may be sufficient to increase the aluminium in the pregnant liquor to its saturation point without precipitating the aluminium as aluminium chloride hexahydrate crystals.

Preferably, the pregnant liquor may be concentrated to its saturation point by evaporation.

In some embodiments, the pregnant liquor may be concentrated by boiling the pregnant liquor at a temperature of between about 95° C. and about 110° C.

In some embodiments, the pregnant liquor may be concentrated to an aluminium concentration of about 60,000 ppm.

At step 40, the saturated solution may be subjected to a crystallisation process.

Any suitable crystallisation process may be used. Preferably, the crystallisation process may include heating the saturated aluminium solution and sparging the saturated aluminium solution with gaseous hydrochloric acid to force crystallisation of and form a slurry of aluminium chloride hexahydrate crystals.

In some embodiments, the saturated aluminium solution may be pre-heated to a temperature of between about 60° C. and about 70° C.

In some embodiments, the saturated aluminium solution may be sparged with gaseous hydrochloric acid held at a reaction temperature of between about 60° C. and about 70° C.

In some embodiments, the saturated aluminium solution may be sparged with gaseous hydrochloric acid until the saturated aluminium solution attains a hydrochloric acid concentration of between about 30% by weight and 34% by weight.

In some embodiments, the slurry of aluminium chloride hexahydrate crystals may be subjected to one or more recrystallisation steps. In this instance, it is envisaged that the slurry of aluminium chloride hexahydrate crystals obtained from the crystallisation of the saturated solution of aluminium chloride hexahydrate may be subjected to one or more recrystallisation steps before undergoing pyrolysis.

The slurry of aluminium chloride hexahydrate crystals may be recrystallised using any suitable technique known in the art. Preferably, the recrystallisation process may comprise separating and washing the precipitated crystals and then dissolving the washed precipitated crystals in a solvent (such as ultra-pure water, demineralised water, or the like) to form a feed liquor. The feed liquor may undergo a polishing step to remove insoluble contaminants such as silica. The feed liquor may then be heated and sparged with gaseous hydrochloric acid to precipitate aluminium chloride hexahydrate crystals.

At step 50, the aluminium chloride hexahydrate crystal slurry may be cooled, and the precipitated aluminium chloride hexahydrate crystals separated from a spent liquor.

The aluminium chloride hexahydrate crystal slurry may be cooled before the aluminium chloride hexahydrate crystals are separated from the spent liquor. Preferably, the aluminium chloride hexahydrate solution may be cooled during the final crystallisation and/or recrystallisation step.

The aluminium chloride hexahydrate solution may be cooled to any suitable temperature. Preferably, the aluminium chloride hexahydrate solution may be cooled to less than about −10° C.

The aluminium chloride hexahydrate solution may be agitated during cooling. In use, it is envisaged that agitating the solution during cooling may assist in avoiding formation of aggregates and assists in the formation of smaller particles.

Advantageously, cooling the aluminium chloride hexahydrate solution to a sufficiently low temperature and agitating the solution during cooling produces crystals with a smaller particle size than traditional practices (less than about 10 μm compared to an average particle size of about 20 μm to about 100 μm) and increases rates of nucleation rather than crystal growth.

The precipitate may be separated using any suitable technique known in the art. Preferably, the separation technique may be sufficient to separate the precipitate from a spent liquor. For instance, the separation technique may include gravity settling clarifiers, sedimentation, decanting, centrifugation, filtration, or the like.

The precipitate may be washed to separate the aluminium chloride hexahydrate crystals from impurities in the precipitate.

The precipitate may be washed with any suitable wash liquid. Generally, the wash liquid may be sufficient to redissolve soluble contaminants or the like from the crystals. The wash liquid may be sufficient to also displace the entrained contaminated supernatant and replace with the less-contaminated wash liquid.

In some embodiments, the wash liquid may be hydrochloric acid, spent liquor, or the like. The wash liquid used to wash a precipitate obtained from the crystallisation of the saturated solution may be the same as the wash liquid used to wash a precipitate obtained from the recrystallisation of a feed liquor, or may be different.

The aluminium chloride hexahydrate crystals may be separated from excess hydrochloric acid using any suitable technique known in the art. For instance, the separation technique may include gravity settling clarifiers, sedimentation, decanting, centrifugation, filtration, or the like.

At step 60, the aluminium chloride hexahydrate crystals may be heated under controlled air flow at a temperature of between about 100° C. and about 350° C. to obtain dehydrated aluminium oxyhydroxychlorides.

Preferably, aluminium chloride hexahydrate crystals may be heated under controlled air flow conditions. Preferably, the aluminium chloride hexahydrate crystals may be heated in a heated vessel under heated and/or dry air flow.

The aluminium chloride hexahydrate crystals may be heated at any suitable hold temperature. Preferably, the aluminium chloride hexahydrate crystals are heated under controlled air flow at a temperature of between about 180° C. and 230° C. to obtain dehydrated aluminium oxyhydroxychlorides.

The aluminium chloride hexahydrate crystals may be heated at a hold temperature for any suitable period of time. Preferably, the aluminium chloride hexahydrate crystals may be agitated while being heated under controlled air flow conditions.

In some embodiments, the dehydrated aluminium oxyhydroxychlorides formed by heating the aluminium chloride hexahydrate crystals comprises residual chloride levels of about 2% by weight to about 10% by weight of the aluminium oxyhydroxychlorides.

In some embodiments, the aluminium oxyhydroxychlorides comprises particles which may pass through a mesh aperture of up to about 10 μm, preferably up to about 5 μm, yet more preferably up to about 2 μm.

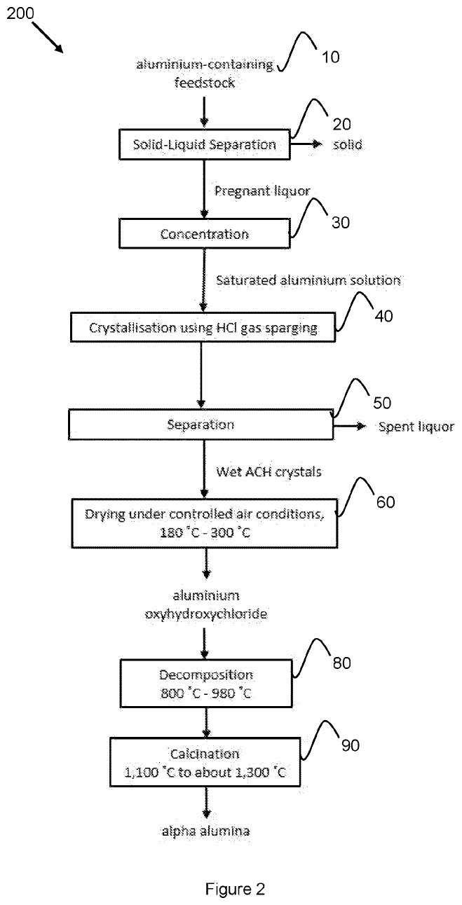

A method (200) for producing an aluminous material as shown in FIG. 2 is now described in detail. Preferably, the aluminous material comprises primarily alpha alumina. The method as illustrated in FIG. 2 and described in the specification is the same as the method illustrated in FIG. 1 and described in the specification with the exception that the aluminous material comprising aluminium oxyhydroxychlorides are subjected to additional processing steps 80 and 90. The method illustrated in FIG. 2 entirely encompasses the method illustrated in FIG. 1. The intermediate product aluminium oxyhydroxychlorides of FIG. 2 may be the same as the end product of FIG. 1.

In this embodiment, it will be understood that method (200) of the present invention provides a three-step pyrolysis to convert aluminium chloride hexahydrate to alpha alumina, wherein the three-step pyrolysis comprises steps 60, 80 and 90.

At step 80, an aluminous material comprising aluminium oxyhydroxychlorides may be decomposed at a temperature of between about 800° C. and about 980° C. to form primarily an amorphous alumina.

The aluminium oxyhydroxychlorides may be decomposed at any suitable temperature. Preferably, the aluminium oxyhydroxychlorides may be heated at a decomposition temperature of between about 800° C. and about 980° C.

In some embodiments, the step of decomposing the aluminous material comprising aluminium oxyhydroxychlorides may comprise controlling the humidity in the vessel.

In some embodiments, the amorphous alumina and gamma alumina formed by decomposing the aluminous material comprising aluminium oxyhydroxychlorides comprises residual chloride levels of less than about 1.5% by weight, preferably less than about 1.0% by weight, more preferably less than about 0.4% by weight of the amorphous alumina and gamma alumina.

At step 90, the amorphous alumina and gamma alumina may be calcined at high temperatures in order to obtain alumina. Preferably, the alumina obtained may comprise substantially alpha alumina.

The amorphous alumina and gamma alumina may be calcined at any suitable temperature. Preferably, the amorphous alumina and gamma alumina may be heated at a calcination temperature of between about 1,100° C. and about 1,300° C.

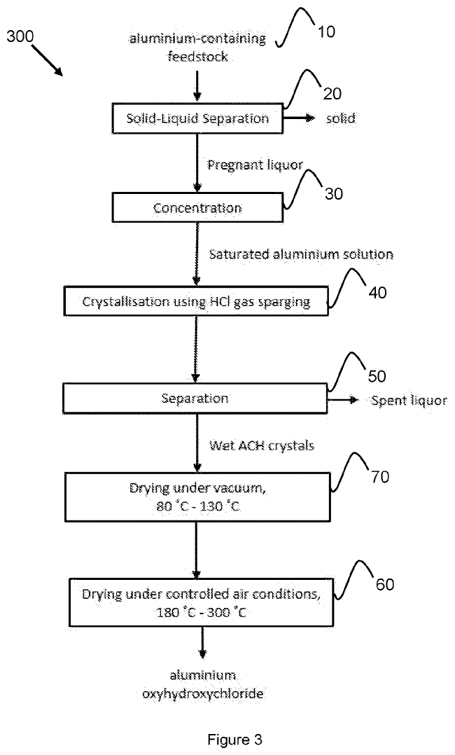

A method (300) for producing an aluminous material as shown in FIG. 3 is now described in detail. Preferably, the aluminous material comprises aluminium oxyhydroxychlorides. The method as illustrated in FIG. 3 and described in the specification is the same as the method illustrated in FIG. 1 and described in the specification with the exception that an additional processing step 70 is used to produce the aluminous material comprising aluminium oxyhydroxychlorides.

Prior to heating step 60, a drying step 70 is used.

At step 70, the aluminium chloride hexahydrate crystals may be dried at a temperature of between about 50° C. and about 150° C. under at least a partial vacuum before the aluminium chloride hexahydrate crystals are heated under controlled air flow at a temperature of between about 100° C. and about 350° C. to obtain aluminium oxyhydroxychlorides.

Preferably, the aluminium chloride hexahydrate crystals may be dried under a pressure of between about 50 mBar to about 1000 mBar.

Preferably, the aluminium chloride hexahydrate crystals may be dried at a temperature of between about 80° C. and about 130° C. under at least a partial vacuum.

In some embodiments, after the step of drying the aluminium chloride hexahydrate crystals under at least a partial vacuum, the aluminium chloride hexahydrate crystals comprise residual chloride levels of about 30% by weight to about 45% by weight of the aluminium chloride hexahydrate crystals.

In some embodiments, the aluminium chloride hexahydrate crystals comprise substantially no residual moisture content.

In use it is envisaged that low temperature heating of aluminium chloride hexahydrate crystals under at least a partial vacuum may assist in reducing entrained liquor, including water, within the crystals to produce stabilised dehydrated aluminium chloride hexahydrate before then being dried to obtain aluminium oxyhydroxychlorides. Advantageously, a low temperature drying stage under at least a partial vacuum (step 70) reduces the drying time of the aluminium chloride hexahydrate crystals at the higher temperature (step 60) and provides an improved energy efficiency than if a one-step drying process was used alone.

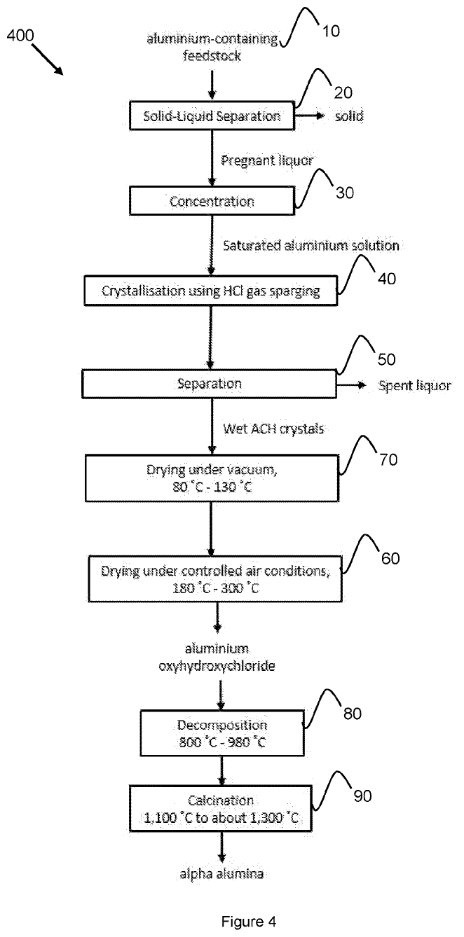

A method (400) for producing an aluminous material as shown in FIG. 4 is now described in detail. Preferably, the aluminous material comprises primarily alpha alumina. The method as illustrated in FIG. 4 and described in the specification is the same as the method illustrated in FIG. 3 and described in the specification with the exception that the aluminous material comprising aluminium oxyhydroxychlorides are subjected to additional processing steps 80 and 90. The method illustrated in FIG. 4 entirely encompasses the method illustrated in FIG. 3. The intermediate product aluminium oxyhydroxychlorides of FIG. 4 may be the same as the end product of FIG. 3.

In this embodiment, it will be understood that method (400) of the present invention provides a four-step pyrolysis to convert aluminium chloride hexahydrate to alpha alumina, wherein the four-step pyrolysis comprises steps 60, 70, 80 and 90.

Steps 10, 20, 30, 40, 50, 60 and 70 in the method as illustrated in FIG. 4 correspond to steps 10, 20, 30, 40, 50, 60 and 70 in the method as illustrated in FIG. 3.

At step 80, an aluminous material comprising aluminium oxyhydroxychlorides may be decomposed at a temperature of between about 800° C. and about 980° C. to form primarily an amorphous alumina.

In some embodiments, the step of decomposing the aluminous material comprising aluminium oxyhydroxychlorides may comprise controlling the humidity in the vessel.

In some embodiments, the amorphous alumina and gamma alumina formed by decomposing the aluminous material comprising aluminium oxyhydroxychlorides comprises residual chloride levels of less than about 1.5% by weight, preferably less than about 1.0% by weight, more preferably less than about 0.4% by weight of the amorphous alumina and gamma alumina.

At step 90, the amorphous alumina and gamma alumina may be calcined at high temperatures in order to obtain alumina. Preferably, the alumina obtained may comprise substantially alpha alumina.

The amorphous alumina and gamma alumina may be calcined at any suitable temperature. Preferably, the amorphous alumina and gamma alumina may be heated at a calcination temperature of between about 1,100° C. and about 1,300° C.

The alpha alumina may undergo one or more further processing steps such as pelletising, sintering, milling, or the like to create products having specific densities, particle sizes, and/or shapes.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

### CITATION LIST

Tilley, G. S.; Millar, R. W. and Ralston, O. C., “Acid Processes for the Extraction of Alumina” US Bureau of Mines, No. 267, 1927.

Hoffman, J. I, Leslie, R. T., Caul, H. J., Clark, L. J. and Hoffman, J. D., “Development of a Hydrochloric Acid Process for the Production of Alumina from Clay”, Journal of Research of the National Bureau of Standards. 1946, vol. 37, pages 409-428.

1. A method for producing an aluminous material including:
providing an aluminium-containing feedstock;
separating the aluminium-containing feedstock to provide a pregnant liquor;
concentrating the pregnant liquor to obtain a saturated aluminium solution; subjecting the saturated aluminium solution to a crystallisation process, the crystallisation process including:
heating the saturated aluminium solution;
sparging the saturated aluminium solution with gaseous hydrochloric acid to form an aluminium chloride hexahydrate crystals slurry;
separating the aluminium chloride hexahydrate crystals from the aluminium chloride hexahydrate crystals slurry to form a spent liquor; and
heating the aluminium chloride hexahydrate crystals under controlled air flow at a temperature of between about 100° C. and about 350° C. to obtain dehydrated aluminium oxyhydroxychlorides.

2. The method for producing an aluminous material according to claim 1, further including: drying the aluminium chloride hexahydrate crystals to a temperature between about 50° C. and 150° C. under at least a partial vacuum before the aluminium chloride hexahydrate crystals are heated under controlled air flow to a temperature of between about 100° C. and about 350° C. to obtain the dehydrated aluminium oxyhydroxychlorides.

3. The method for producing an aluminous material according to claim 1, further including: decomposing the aluminium oxyhydroxychlorides at a temperature of between about 800° C. and about 980° C. to form primarily an amorphous alumina, and calcining the amorphous alumina at a temperature of between about 1,100° C. and about 1,300° C. to obtain primarily alpha alumina.

4. The method for producing an aluminous material according to claim 1, wherein drying the aluminium chloride hexahydrate crystals at a temperature of between about 50° C. and 150° C. under at least a partial vacuum is undertaken using microwave vacuum-assisted drying.

5. The method for producing an aluminous material according to claim 1, wherein the pregnant liquor is concentrated to its saturation point by evaporation.

6. The method for producing an aluminous material according to claim 1, wherein the aluminium chloride hexahydrate crystals slurry is subjected to one or more recrystallisation processes.

7. The method according to claim 1, wherein the aluminium-containing feedstock comprises an aluminium-containing material including aluminium hydroxide, aluminium metal, aluminium chloride hexahydrate, red mud, fly ash, mineral processing waste streams, aluminosilicates, kaolin, zeolite or feldspar.

8. The method according to claim 1, wherein the aluminium-containing feedstock is formed by dispersing the aluminium-containing material in a solvent.

9. The method according to claim 1, wherein the aluminium-containing feedstock is separated using gravity settling clarifiers, sedimentation, decanting, centrifugation or filtration.

10. The method according to claim 1, wherein the aluminium-containing feedstock is separated into the pregnant liquor and a solid residue.

11. The method according to claim 1, wherein the pregnant liquor is concentrated to obtain the saturated aluminium solution by boiling or evaporation.

12. The method according to claim 1, wherein the pregnant liquor is concentrated such that the aluminium concentration of the saturated aluminium solution is between about 50,000 ppm and 70,000 ppm.

13. The method according to claim 1, wherein the saturated aluminium solution is pre-heated to a temperature of between about 50° C. and about 80° C.

14. The method according to claim 1, wherein the saturated aluminium solution may be sparged with gaseous hydrochloric acid at a reaction temperature of between about 60° C. and about 100° C.

15. The method according to claim 1, wherein the saturated aluminium solution may be sparged with gaseous hydrochloric acid until the saturated aluminium solution attains a hydrochloric acid concentration of between about 30% by weight and 35% by weight.

16. The method according to claim 1, wherein the aluminium chloride hexahydrate crystals slurry is subjected to one or more recrystallisation steps before undergoing pyrolysis.

17. The method according to claim 16, wherein the one or more recrystallisation steps are configured to precipitate purified aluminium chloride hexahydrate crystals from the aluminium chloride hexahydrate crystals slurry.

18. The method according to claim 17, wherein the purified aluminium chloride hexahydrate crystals are separated from the aluminium chloride hexahydrate crystals slurry and dissolved to form a feed liquor.

19. The method according to claim 18, wherein the feed liquor is polished to remove insoluble contaminants.

20. The method according to claim 19, wherein, after the removal of the insoluble contaminants, the feed liquor is heated and sparged with gaseous hydrochloric acid to precipitate aluminium chloride hexahydrate crystals.

21. The method according to claim 1, wherein the aluminium chloride hexahydrate crystals slurry is cooled to a temperature of less than about −10° C. prior to separating the aluminium chloride hexahydrate crystals from the spent liquor.

22. The method according to claim 1, wherein the aluminium chloride hexahydrate crystals slurry is agitated during cooling to produce aluminium chloride hexahydrate crystals having a particle size of less than about 10 μm.

23. The method according to claim 1, wherein the aluminium chloride hexahydrate crystals are heated in a forced air-drying oven, a flash dryer or a fluidised bed dryer.

24. The method according to claim 1, wherein the aluminium chloride hexahydrate crystals are heated at a ramp rate of at least about 75° C. per minute to reach the temperature at which aluminium oxyhydroxychlorides are obtained.

25. The method according to claim 1, wherein the aluminium chloride hexahydrate crystals are agitated during heating in order to assist in deagglomeration and/or particle size reduction of the crystals.

26. The method according to claim 1, wherein the aluminium oxyhydroxychlorides formed by heating the aluminium chloride hexahydrate crystals comprises residual chloride levels of about 2% by weight to about 12% by weight of the dehydrated aluminium oxyhydroxychlorides.

27. The method according to claim 2, wherein the aluminium chloride hexahydrate crystals are dried under a pressure of between about 250 mBar and about 600 mBar.

28. The method according to claim 2, wherein the aluminium chloride hexahydrate crystals comprise residual chloride levels of about 30% by weight to about 45% by weight of the aluminium chloride hexahydrate crystals after the step of drying the aluminium chloride hexahydrate crystals under at least a partial vacuum.

29. The method according to claim 3, wherein decomposing the aluminium oxyhydroxychlorides primarily forms the amorphous alumina as well as gamma alumina.

30. The method according to claim 29, wherein the amorphous alumina and the gamma alumina comprise residual chloride levels of less than about 0.4% by weight.
